(19) United States
(12) Patent Application Publication
(10) Pub. No.: US 2002/0026361 A1
(43) Pub. Date: Feb. 28, 2002

(54) Position-based advertisement broker

(76) Inventor: Jonas Blom, Linkoping (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/907,629

(22) Filed: Jul. 19, 2001

Related U.S. Application Data
(60) Provisional application No. 60/219,441, filed on Jul. 20, 2000.

(51) Int. Cl. G06F 17/60; G06F 15/16

(52) U.S. Cl. 705/14; 709/201

(57) ABSTRACT

A position-based advertisement broker receives advertisements from advertisers and provides the advertisements to mobile stations. To provide the advertisements, the advertisement broker receives location information from the advertiser associated with a particular advertisement. The advertisement broker provides a mobile station, via a mobile Internet service provider and a mobile network, with the advertisement if the position of the mobile station is within the location associated with the advertisement.

The present application claims priority under 35 U.S.C. §119(e) to U.S. Provisional Application No. 60/219,441 filed Jul. 20, 2000, the entire disclosure of which is herein expressly incorporated by reference.

### BACKGROUND

The present invention relates to advertisements, and more particularly, to methods and systems for providing position-based advertisements.

The recent proliferation of mobile stations such as cellular telephones, personal digital assistants, and portable computers equipped with wireless modems, has made it desirable to provide location specific information to users of such devices. One application which uses location specific information of mobile users is advertising. It will be recognized that in order to maximize the return on any particular advertisement, advertisers desire to provide their advertisements to a demographic which is most likely to be interested in the particular advertisement. For example, in order to minimize the expense of advertising, a small restaurant may wish to advertise only to those people who are currently in the vicinity of the restaurant, e.g., by placing the advertisement on a billboard in the vicinity of the restaurant. Accordingly, by providing the advertisement based upon location specific information, an advertiser's money need not be wasted on advertisements provided to people who are not currently in the vicinity of the advertiser.

Although there are known systems which provide location specific advertisements, these systems do not currently provide the most efficient methods for an advertiser to implement location specific advertisements. For example, U.S. Pat. No. 6,047,327 to Tso et al. discloses a system for distributing electronic information to a targeted group of users. The system of Tso et al. employs a push technology which takes information from content providers, filters the information based upon client preferences and provides the filtered information to clients. However, the content providers disclosed by Tso et al. are described as being Internet servers such as an HTTP server. However, not all advertisers have the time or money to expend in the procurement, designing and running of an Internet server for the purpose of providing advertisements to end users.

Accordingly, it would be desirable to provide a location based advertisement system for mobile users which minimizes the burden on the advertisers in providing the advertisements to mobile stations.

### SUMMARY OF THE INVENTION

The present invention provides methods and systems for position-based advertising. More specifically, the present invention employs a positioned-based advertisement broker which interacts between advertisers and a mobile Internet service provider (ISP) to provide advertisements to subscribers of the mobile ISP. A position-based advertisement broker simplifies the provision of position-based advertisement through a mobile ISP by reducing the amount of hardware and/or software required of the mobile ISP while providing a mobile ISP with a revenue stream for providing the position-based advertisements to subscribers of the mobile ISP. Further, a position-based advertisement broker eliminates the need for an advertiser to manage the initiation of the push of the advertisement to the mobile station.

In accordance with one embodiment of the present invention, an advertisement broker receives position information associated with a mobile station. The advertisement broker also receives an advertisement and location from an advertiser. Based on the position information it is determined whether the mobile station is within the location provided by the advertiser. The advertisement is provided to an Internet service provider if the position information indicates that the mobile station is within the location.

In accordance with one aspect of the present invention, advertisements are provided to mobile users in an electronic mail. Further, to assist in the determination of the position of mobile stations, a mobile ISP provides the position information of selected mobile stations to the advertisement broker. The position information can be continually provided by the mobile ISP, either based upon a predetermined schedule or when the position of a mobile station changes. Alternatively, the advertisement broker can send a request to the mobile ISP requesting the position information of selected mobile stations.

### BRIEF DESCRIPTION OF THE DRAWINGS

FIG. 1 illustrates a communications network for mobile Internet access;

FIG. 2 illustrates a communications network for providing position-based advertisements in accordance with an exemplary embodiment of the present invention;

FIG. 3 illustrates a position-based broker in accordance with exemplary embodiments of the present invention;

FIG. 4 illustrates an exemplary method for collecting position information in accordance with the present invention; and

FIG. 5 illustrates an exemplary method for providing position-based advertisements to a mobile station in accordance with the present invention.

### DETAILED DESCRIPTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods, devices, and circuits are omitted so as not to obscure the description of the present invention.

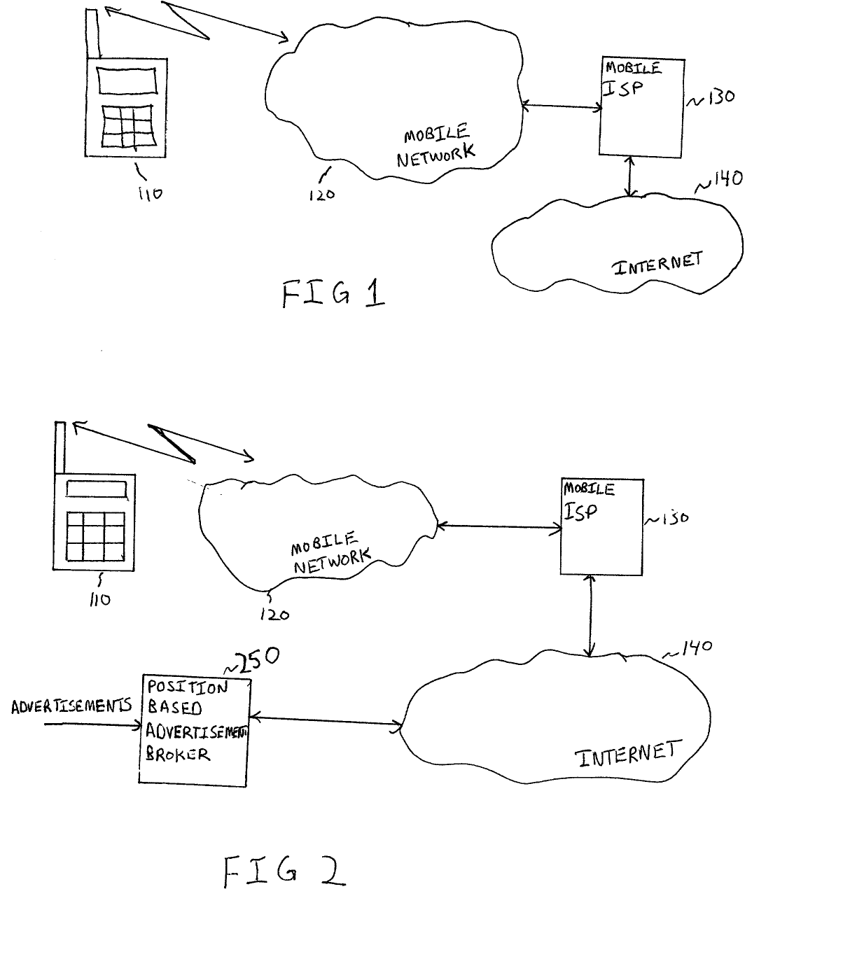

FIG. 1 illustrates an exemplary communications network for mobile Internet access. The communications network includes a mobile station 110, a mobile network 120, a mobile Internet service provider (ISP) 130 and the Internet 140. In the communications network illustrated in FIG. 1, when mobile station 110 wishes to access the Internet 140, the communication is initially routed through an air interface from mobile station 110 to the mobile network 120. Mobile network 120 then forwards the relevant information received from mobile station 110 to mobile ISP 130, which, in turn, provides this information to the Internet 140. In response, the information requested from the Internet is provided to mobile ISP 130, which, in turn, provides it to the mobile network 120. Mobile network 120 then provides the requested information over an air interface to mobile station 110.

In addition to other types of information that can be provided, the mobile network 120 can provide the mobile ISP 130 with position information related to the current position of mobile station 110. This position information can be as general as the particular cell, including macro cells, micro cells and pico cells, in which mobile station 110 is located. Alternatively, more precise position information can be obtained using techniques such as triangulation or mobile station equipped GPS positioning.

Using the telecommunications network illustrated in FIG. 1, there are several methods for employing position-based advertisements. One method for providing position-based advertisements in the network illustrated in FIG. 1 is for the system to reside entirely in the mobile ISP 130. In accordance with this method, the company that wishes to send advertisements, provides information to the mobile ISP 130 regarding the rules for when and where to send these advertisements. However, such a method increases the administrative burden on a mobile ISP. For example, a mobile ISP would have to interface with and contract with the individual advertisers. Moreover, implementation of such a method by a mobile ISP may require additional hardware and/or software by the mobile ISP, which, in turn, increases the up front expense to the mobile ISP.

Another method for implementing position-based advertisements in the communications network illustrated in FIG. 1 is for the company wishing to send the advertisements to interface directly with the mobile ISP. In accordance with this method, the company wishing to send position-based advertisements would have to obtain position information from the mobile ISP and, in response, initiate the pushing of the advertisements to the mobile stations. This method requires the procurement of hardware and software by the company wishing to advertise, which for small businesses would be prohibitively expensive. In addition, the mobile ISP will have increased administrative expenses due to the need to implement interfaces toward each company wishing to advertise using the mobile ISP. Further, an advertiser would have to set up contracts with each mobile ISP through which the advertiser wished to reach mobile stations.

FIG. 2 illustrates a communications network in accordance with exemplary embodiments of the present invention. In FIG. 2, elements which are similar to those described in connection with FIG. 1 are marked with the same reference numerals. Accordingly, in addition to mobile station 110, mobile network 120, mobile ISP 130, and Internet 140, the communications network of FIG. 2 includes a position-based advertisement broker 250.

In accordance with the present invention, an advertiser who desires to provide advertisements to mobile stations would contact a position-based advertisement broker 250. The advertiser would provide the position-based advertisement broker 250 with the advertisement and the location information which defines to which mobile stations the advertisements should be sent. The advertisement can be coded in accordance with eTensible Markup Language (XML). The position-based advertisement broker 250 obtains position information from mobile ISP 130 and provides mobile ISP 130 with advertisements to be pushed to mobile station 110. The advertisements can be sent in an electronic mail, as a short message service (SMS) message, unstructured supplementary service data (USSD), or any other means in which the mobile station can reproduce the advertisement to the subscriber.

In accordance with exemplary embodiments of the present invention, only those mobile stations which subscribe to the advertisement service provided by position-based advertisement broker 250 would receive these advertisements. In exchange for receiving the advertisements by their mobile stations, subscribers may receive some type of compensation, for example, monetary compensation and/or free air time. Another type of compensation to subscribers could be providing subscribers who allow advertisements to be provided to their mobile station with coupons in connection with the advertisements which can be used at the company associated with the advertisement.

Although FIG. 2 illustrates a single mobile ISP, the present invention is equally applicable to multiple mobile ISPs. Accordingly, the position-based advertisement broker can provide advertisements to any of the mobile stations which subscribe to the mobile ISPs with which the advertisement broker has an agreement with. Accordingly, an advertiser need only contract with the position based advertisement broker to reach mobile stations of multiple different mobile ISPs, whereas in some conventional systems the advertiser would have to enter into contracts with each mobile ISP that the advertiser wishes to reach mobile subscriber's of each mobile ISP.

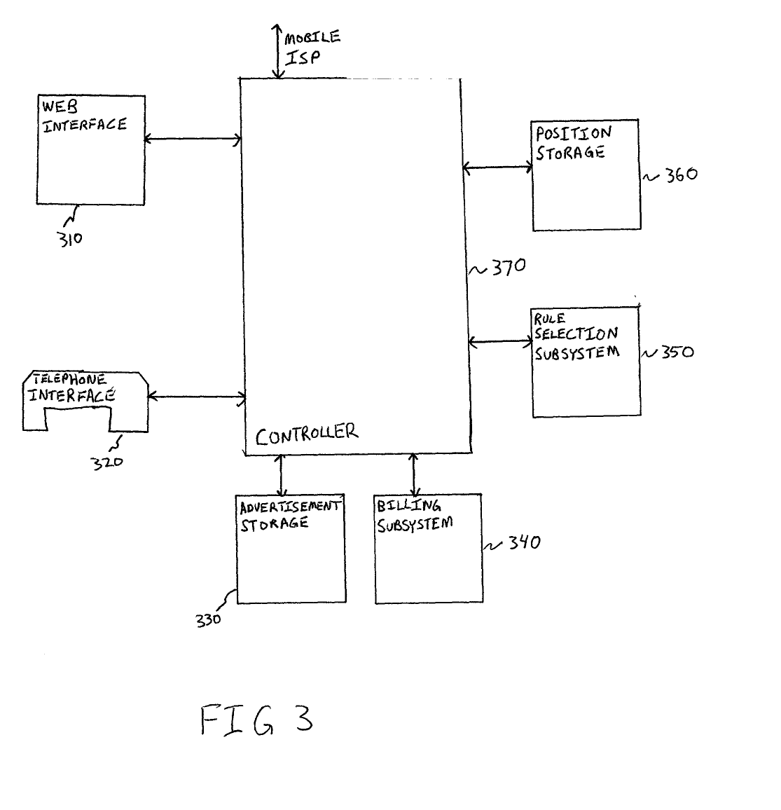

FIG. 3 illustrates a position-based advertisement broker in accordance with exemplary embodiments of the present invention. The position-based advertisement broker includes web interface 310, telephone interface 320, advertisement storage unit 330, billing subsystem 340, rule selection subsystem 350, position storage unit 360, and controller 370. Although the various elements which comprise the position-based advertisement broker in FIG. 3 are illustrated as separate components, this is done merely for clarity of explanation and is not intended to limit the present invention. For example, it will be recognized that the position-based advertisement broker can be a computer running appropriate software which performs the function of the illustrated subsystems and interfaces. Further, advertisement storage and position storage can be a single storage unit.

In order to place an advertisement with the position-based advertisement broker, an advertiser would interact via either a web interface 310 or telephone interface 320. It will be recognized that in addition to web interface 310 and telephone interface 320, the advertiser can contact the position-based advertisement broker via traditional paper correspondence via known mail delivery systems, via facsimile or any other means of communication. Using either web interface 310 or telephone interface 320, the advertiser provides the advertisement and the location associated with the advertisement to the position-based advertisement broker. The position-based advertisement broker stores the advertisement and the associated location information in advertisement storage unit 330. The position-based advertisement broker requests the location of all subscribers of the position-based advertisement services from the mobile ISP and stores such position information in position storage unit 360. Alternatively, the mobile ISP can provide the position information to the position-based advertisement broker automatically, either based upon a predetermined schedule or when the position of the mobile station changes.

Controller 370 controls the overall operation of position-based advertisement broker. Particularly, controller 370 makes the correspondence between the location information associated with particular advertisements stored in advertisement storage unit 330 and the position of mobile stations stored in position storage unit 360. In addition to providing advertisements solely based upon the position of a mobile station, other rules such as time of day, day of the week and/or month of the year, or any other type of demographic may be used for selecting a particular advertisement for a particular mobile station. This type of information can be stored in rule selection subsystem 350.

The accounting for each advertisement provided to a mobile station is handled by billing subsystem 340. This accounting can include payment to subscribers who allow their mobile stations to receive advertisements, payment to mobile ISPs for providing position information of mobile stations and for carrying the advertisements over their network, and billing the advertisers for providing the advertisement service. Any type of payment model can be employed by the present invention, including, but not limited to, payment for each advertisement sent, payment of a fixed cost per month, or payment for each advertisement which results in a sale for the advertiser.

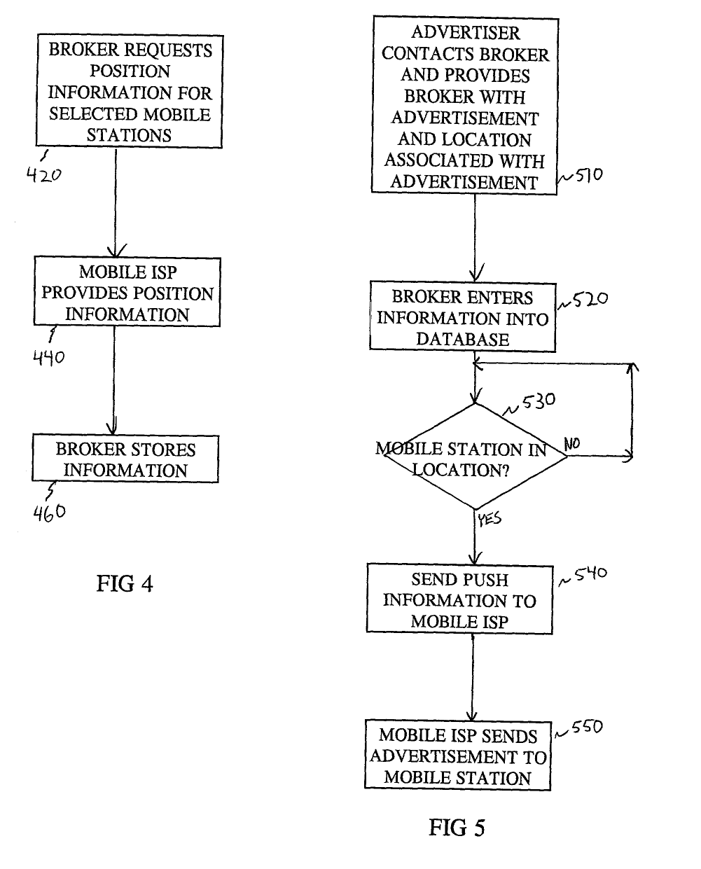

FIG. 4 illustrates an exemplary method for obtaining position information associated with mobile stations. Initially, a broker requests position information for selected mobile stations (step 420). The selected mobile stations are mobile stations which have a subscription with the position-based advertisement broker. Next, the mobile ISP provides the position information to the advertisement broker (step 440). Finally, the advertisement broker stores the position information associated with the mobile stations (step 460). It should be recognized that the process illustrated in FIG. 4 is repeated periodically such that the advertisement broker maintains recent position information in its database. Additionally, a flag may be placed within a component of the mobile network, e.g., within the home location register, for notifying the mobile ISP upon changes of location of a mobile station, e.g., movement from one cell to another cell. The mobile ISP can then inform the advertisement broker of the new location of the mobile station. Alternatively, the mobile ISP can provide position information based upon a predetermined schedule.

FIG. 5 illustrates an exemplary method for providing advertisements to mobile stations in accordance with the present invention. Initially, an advertiser contacts an advertisement broker and provides the advertisement broker with a particular advertisement and a location associated with the advertisement (step 510). This contact can be performed using a web interface, a telephone interface or any other communication means. The broker enters this information either automatically or manually into its database (step 520) and determines whether the position of a mobile station is within the location specified by any of the advertisers using the position-based advertisement broker (step 530). If the position-based advertisement broker determines that the mobile station is not currently in a location associated with an advertisement (“No” path out of decision step 530) then the position-based advertisement broker continues to determine whether the position of a mobile station is in a location associated with a particular advertisement. If, however, the position of a mobile station is in a location associated with an advertisement (“Yes” path out of decision step 530) then the advertisement broker sends the particular advertisement to the mobile ISP (step 540). The mobile ISP, in turn, provides the advertisement to the mobile station (step 550). It should be recognized that once the advertisement information is stored in the database the process proceeds in accordance with steps 530-550 to provide the advertisements to the mobile stations.

The present invention has been described with reference to several exemplary embodiments. However, it will be readily apparent to those skilled in the art that it is possible to embody the invention in specific forms other than those of the exemplary embodiments described above. This may be done without departing from the spirit of the invention. These exemplary embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method for providing advertisements in a communications network comprising the steps of:
receiving, by an advertisement broker, position information associated with a mobile station;
receiving, by the advertisement broker, an advertisement and location from an advertiser;
determining, based on the position information, whether the mobile station is within the location provided by the advertiser; and
providing the advertisement to an Internet service provider if the position information indicates that the mobile station is within the location.

2. The method of claim 1, wherein the Internet service provider is a mobile Internet service provider.

3. The method of claim 1, wherein the position information and the location information indicate a particular cell in a cellular system.

4. The method of claim 1, wherein the location information is a predetermined radius surrounding a geographical location and wherein the advertisement broker maps the location information into cells of a cellular system.

5. The method of claim 1, wherein the determining step further comprises the step of:
determining a time of the day, wherein the advertisement is provided to the Internet service provider in the position information indicates that the mobile station is within the location and if the time of day is within a predetermined time associated with the advertisement.

6. The method of claim 1, wherein the position information is provided by the Internet service provider, the method further comprises the steps of:
receiving, by the advertisement broker, position information associated with another mobile station, where the position information associated with another mobile station is provided by another Internet service provider.

7. The method of claim 1, wherein a subscriber associated with the mobile station is compensated for receiving the advertisement.

8. The method of claim 1, wherein the Internet service provider is compensated for providing the position information and providing the position information.

9. The method of claim 1, wherein the advertisement is provided by the advertiser through the Internet to the advertisement broker.

10. The method of claim 1, wherein the advertisement broker receives the position information associated with the mobile station only when the mobile station changes cells.

11. An advertisement broker comprising:
means for receiving position information associated with a mobile station;
means for receiving an advertisement and location from an advertiser;
a controller which determines, based on the position information, whether the mobile station is within the location provided by the advertiser; and
an interface for providing the advertisement to an Internet service provider if the position information indicates that the mobile station is within the location.

12. The advertisement broker of claim 11, wherein the position information and the location information indicate a particular cell in a cellular system.

13. The advertisement broker of claim 11, wherein the location information is a predetermined radius surrounding a geographical location and wherein the advertisement broker maps the location information into cells of a cellular system.

14. The advertisement broker of claim 11, wherein the controller also determines a time of the day, wherein the advertisement is provided to the Internet service provider in the position information indicates that the mobile station is within the location and if the time of day is within a predetermined time associated with the advertisement.

15. The advertisement broker of claim 11, wherein the position information is provided by the Internet service provider, the advertisement broker further comprises:
means for receiving position information associated with another mobile station, where the position information associated with another mobile station is provided by another Internet service provider.

16. The advertisement broker of claim 11, wherein a subscriber associated with the mobile station is compensated for receiving the advertisement.

17. The advertisement broker of claim 11, wherein the Internet service provider is compensated for providing the position information and providing the position information.

18. The advertisement broker of claim 11, wherein the advertisement is provided by the advertiser through the Internet to the advertisement broker.

19. The advertisement broker of claim 11, wherein the advertisement broker receives the position information associated with the mobile station only when the mobile station changes cells.
